(19) United States
(12) Patent Application Publication
(10) Pub. No.: US 2004/0242834 A1
(43) Pub. Date: Dec. 2, 2004

(54) Phenolic resin, epoxy resin, processes for production thereof and epoxy resin composition

(76) Inventor: Ryuichi Ueno, Kanagawa (JP)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/490,828

(22) PCT Filed: Sep. 19, 2002
(86) PCT No.: PCT/JP02/09630

(30) Foreign Application Priority Data
Sep. 28, 2001 (JP) 2001-299335

(51) Int. Cl. C08G 59/00; C08G 65/08; C08G 63/78; C08G 65/14; C08G 63/87

(52) U.S. Cl. 528/87; 528/205

(57) ABSTRACT

To improve moldability by improving fluidity of resins, and to provide cured substances with favorable heat resistance, relating to the phenol resins and epoxy resins useful as the resins for semiconductor sealing materials. When producing a phenol resin obtained by reacting phenols with dicyclopentadiene in the presence of an acid catalyst, the phenol resin is made to contain in itself specific quantities of the compound A represented by the following general formula (1) and the compound B represented by the following formula (2) by making an aromatic hydrocarbon compound coexist in the phenols at the time of the reaction.

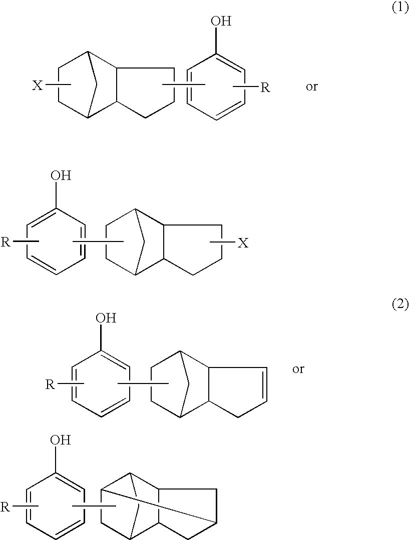

(where X means an aromatic hydrocarbon, and R means a proper number of arbitrary atoms or groups.)

### BACKGROUND OF THE INVENTION

1. Field of the Invention

The present invention relates to phenol resins, epoxy resins, and compositions for semiconductor sealing materials, which are useful as electrical insulating materials, especially, resins for semiconductor sealing materials and those for laminated sheets, further effective for various forms of moldings or the like, and excellent in heat resistance, moisture resistance, crack resistance, and moldability.

2. Detailed Description of the Prior Art

In recent years, there has been a remarkable progress in the semiconductor and associated technologies, and semiconductor memory is increasingly being improved in the degree of integration. Associated with this, minute-making of wiring, upsizing of chips, and shifting from through-hole mounting to surface mounting are going on. However, there are problems that in an automated surface mounting line, a semiconductor package is influenced by a sudden change in temperature at the time of soldering lead wires, and this causes a crack in a resin molding part as a semiconductor sealing material, or the interfaces between lead wire and resins is deteriorated to lower moisture resistance.

Conventionally, phenol resins such as a novolac phenol resin and a novolac cresol resin have been used as a curing agent in the resin compositions for a semiconductor sealing material, and moreover, as a base resin, an epoxy resin having a novolac cresol structure has been used. However, there are problems that when these resins are used, a moisture absorption characteristic of the semiconductor package is not satisfactory, and as a result an occurrence of an unavoidable crack is unavoidable at the time of dipping the package in a solder bath and they are moreover inferior in fluidity.

Therefore, in recent years, to improve moisture resistance and heat resistance of the resin compositions for semiconductor sealing material, studies have been made for improving phenol resins as raw materials of epoxy resins and curing agents therefore, and for example, the Japanese Patent Laid-open No.S61-291615 has proposed an epoxy resin composition which comprises, as an essential component, an epoxy resin derived from phenols and dicyclopentadiene (hereafter, this may be called DCPD) and has an excellent balance of moisture resistance, heat resistance, and internal plasticity. However, the moldability of the composition is not necessarily evaluated as sufficient.

Moreover, the Japanese Patent Laid-open No.H09-48839 describes that fluidity can be obtained without losing heat resistance by means of adjusting a quantity of a low molecular weight component in the DCPD-phenol modified epoxy resin, and that the adjustment of the quantity of the low molecular weight component in this case is performed by distilling or re-precipitating the epoxy resin or the phenol resin as the raw material of the epoxy resin. However, there is a problem that the quantity adjustment by distillation method is difficult, and a remaining quantity of phenol in the resin increases, or the like. Moreover, there is another problem that, through the re-precipitation method is carried out by using a solvent, the solvent needs to be removed from the resin again, or the like.

### SUMMARY OF THE INVENTION

The problems to be solved by the present invention are to provide a phenol resin, an epoxy resin, and an epoxy resin composition using these resins, which are excellent in heat resistance after sealing and curing, and have moreover favorable fluidity and moldability when sealing semiconductors, and to provide a production method therefor.

As a result of zealous studies for a solution of the above problems, the applicants of the present invention have found out that a resin characteristic can be controlled by adjusting the content of the compound A, which is produced by making an aromatic hydrocarbon compound with 6 to 10 carbon numbers coexist during reacting, and further the compound B in the phenol resin obtained by reacting phenols with dicyclopentadiene in the presence of an acid catalyst, and that moldability can be improved by improving fluidity without decreasing the heat resistance of the cured substance by using the phenol resin or the epoxy resin derived therefrom, thereby completing the present invention.

Namely, the present invention relates to the phenol resin which can be obtained by reacting dicyclopentadiene with phenols in the presence of an acid catalyst, characterized in containing at least 0.1 mass % of the compound A represented by the general formula (1) described below and moreover containing 0.1 to 5 mass % as a summed quantity of the compound A and the compound B represented by the general formula (2) described below.

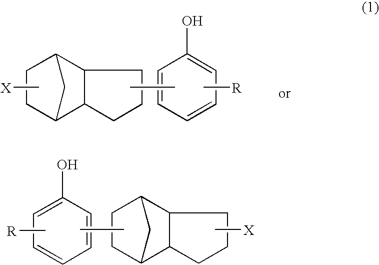

(where X is an aromatic hydrocarbon with 6 to 10 carbon numbers, the kind of R and the number of bonds to the aromatic ring will be determined depending on kinds of phenols to be used for the reaction.)

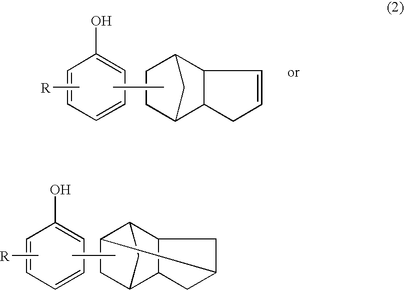

(where the kind of R and the number of bonds to the aromatic ring will be determined depending on the kinds of phenols to be used for the reaction.)

Moreover, the present invention relates to a production method of a phenol resin containing the compound A at least by 0.1 mass % and a 0.1 to 5 mass % summed quantity of the compound A and the compound B by making 0.5 to 20 parts by weight of aromatic hydrocarbon compound coexist with 100 parts by weight of the phenols when producing the phenol resin by reacting dicyclopentadiene with phenols in the presence of an acid catalyst.

Further, the present invention relates to an epoxy resin obtained by the reaction between the above phenol resin and the epihalohydrins, and the production method of the same, and preferably, the production method comprises 1) a process for producing the phenol resin by the above production method, and 2) a process for producing the epoxy resin by reacting the phenol resin obtained by the process 1 with epihalohydrins.

Moreover, the present invention relates to the resin composition for a semiconductor sealing material containing an epoxy resin, a curing agent, a curing accelerator, and an inorganic filler as essential components, for which the above phenol resin is used as the curing agent, or the above epoxy resin is used as the epoxy resin.

### DETAILED DESCRIPTION OF THE PREFERRED EMBODIMENT

The present invention will be explained more in details in the following.

Firstly, a phenol resin with favorable heat resistance and fluidity and the production method of the same will be explained.

The phenol resin in accordance with the present invention is produced by reacting phenols having a phenolic hydroxyl group with dicyclopentadiene in the presence of an acid catalyst.

The dicyclopentadiene used as the raw material of the phenol resin of the present invention is contained in petroleum fraction of distillate and is industrially available at an inexpensive price. Any dicyclopentadiene industrially available can be used, however, a purity of 90 mass % or higher is preferable for the use, and a purity of 95 mass % or higher is more preferable for the use.

Although the phenols are not specially restricted, for example, monohydric phenols suchs as phenol, o-cresol, m-cresol, p-cresol, o-ethylphenol, m-ethylphenol, p-ethylphenol, o-isopropylphenol, m-propylphenol, p-propylphenol, p-sec-butylphenol, p-tert-butylphenol, p-cyclohexylphenol, p-chlorophenol, o-bromophenol, m-bromophenol, p-bromophenol, α-naphthol, and β-naphthol; dihydric phenols such as resorcin, catechol, hydroquinone, 2,2-bis(4′-hydroxyphenyl)propane, 1,1′-bis(dihydroxyphenyl)methane, 1,1′-bis(dihydroxynaphthyl)methane, tetramethylbiphenol, and biphenol; and trihydric phenols such as tris(hydroxyphenyl)methane can be exemplified. Especially, phenol, o-cresol, m-cresol, and the like, are preferable from the viewpoints of economy and ease of production. These can be used solely or mixed.

A mole ratio of phenols to dicyclopentadiene to be used for the reaction is not specially limited because the molecular weight and melt viscosity of the target phenol resin can be adjusted within a proper range by adjusting the mole ratio as necessary, however, a normal ratio of phenols to dicyclopentadiene is 1 to 20 (mole ratio). Especially, when the mole ratio of dicyclopentadiene is made small, the molecular weight of the phenol resin to be obtained becomes small and the melt viscosity becomes lower, therefore, it is favorable, as the use for a semiconductor sealing material or the like, that high filling of a filler is possible, a coefficient of linear expansion becomes small; and further, the moisture resistance is improved. To be more specific, a ratio of phenols to dicyclopentadiene is preferred to be within a range of 1 to 15 (mole ratio).

As acid catalysts, inorganic acids such as hydrochloric acid, sulfuric acid, and nitric acid, and organic acids such as formic acid, acetic acid, and oxalic acid can be exemplified, and further, as Friedel-Crafts catalysts, boron-trifluoride, boron-trifluoride/ether complex, boron-trifluoride/phenol complex, boron-trifluoride/water complex, boron-trifluoride/alcohol complex, boron-trifluoride/amine complex, and the like, can be mentioned, and a mixture of these or the like, can be used. Among them, boron-trifluoride, boron-trifluoride/phenol complex, boron-trifluoride/ether complex are especially preferred for the use from the viewpoints of catalyst activity and ease of catalyst removal.

A use amount of a catalyst is not specially limited for bringing the molecular weight and melt viscosity of the phenol into an appropriate range, however, for example, when phenol and dicyclopentadiene are made to react with each other catalyzed by boron-trifluoride/phenol complex, a ratio of boron-trifluoride to (phenol+dicyclopentdiene) is within a range of approximately 0.05 to 1.5 mass %, preferably 0.15 to 1 mass %.

To prevent a side reaction or the like, phenols and dicyclopentadiene to be used for the reaction are preferred to contain a 200 ppm or less moisture content. Although a dehydrating method is not specially specified, for example, a method through azeotropy of phenols with an organic solvent in a nitrogen gas flow can be mentioned.

In the reaction, normally, the inside of the reactor is replaced with an inert gas such as nitrogen and argon, and the reaction in a closed system is preferred, but may be carried out in an open system while supplying the inert gas into the reactor.

In the present invention, when phenols and dicyclopentadiene are made to react with each other in the presence of an acid catalyst, the reaction is carried out with an aromatic hydrocarbon compound with 6 to 10 carbon numbers made to coexist therein. As the aromatic hydrocarbon compounds with 6 to 10 carbon numbers, for example, benzene, toluene, o-xylene, p-xylene, m-xylene, and the like, are preferable, but among them, toluene is especially preferred from the viewpoint of reactivity.

In order to provide the obtainable phenol resin with favorable curing performance and moldability, it is important that an amount of the compound A represented by the below-mentioned general formula (1) is made to be not less than 0.1 mass % of the whole resin amount. For this purpose, a use amount of the aromatic hydrocarbon compound is preferred to be 0.5 to 20 parts by weight to 100 parts by weight of the phenols.

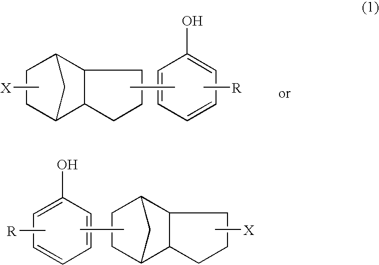

(where X is an aromatic hydrocarbon with 6 to 10 carbon numbers, the kind of R and the number of bonds to the aromatic ring are determined depending on the kind of the phenols to be used for the reaction, and although not specially restricted, the typical kinds are hydrogen, methyl group, hydroxyl group, bromine, and the like)

Although the reaction method is not specially specified, for example the reaction is carried out by preparing a specified quantity of phenols, an aromatic hydrocarbon compound, and an acid catalyst in the reactor, and then dropping dicyclopentadiene into it.

Further, the reaction is ended by inactivating the catalyst. Although the mean of inactivation is not specifically restricted, such a mean is preferred to be taken, as a remaining amount of ionic impurities such as bromine and fluorine in the phenol resin finally obtained does not exceed 100 ppm.

As inactivators used for this purpose, inorganic bases such as alkaline metal, alkaline earth metal or their oxides, hydroxides, carbonates, ammonium hydroxide, and ammonia gas can be used, however, it is preferable to use hydrotalcite from the viewpoints of its simple and speedy treatment, and a small remaining amount of the ionic impurities after the treatment.

The inactivator or the like are removed by filtration from the reaction liquid that has completed the reaction and the reaction liquid without containing the impurities is recovered. For filtration, workability can be improved by adding a solvent, raising the temperature of the filtrate, and putting the system under pressurization or reduced pressure condition.

Unreacting phenols or the like, are removed and recovered from the filtered reaction liquid by distillation and concentration. The distillation can be performed under any of a normal pressure, pressurized, and reduced pressure conditions.

In order to provide the obtainable phenol resin with favorable curing performance and moldability and moreover provide it with excellent heat resistance, moisture resistance, and crack-resistant property after curing, it is necessary that the content of the compound A represented by the formula (1) is adjusted at least to 0.1 mass % or higher, and that the sum of the compound A and the compound B represented by the general formula (2) mentioned below is adjusted to 0.1 to 5 mass %.

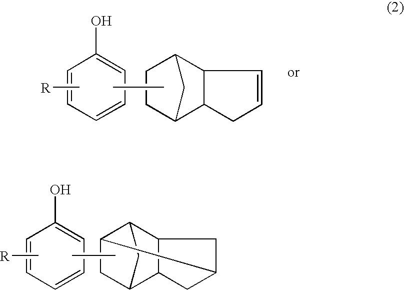

(where the kind of R and the number of bonds to the aromatic ring are determined depending on the kind of the phenols used for the reaction, and although it is not restricted, the typical kinds are hydrogen, methyl group, hydroxyl group, bromine, and the like)

Moreover, considering the balance of fluidity and curing performance, it is preferable that the content of the compound A is 1 to 3 mass %, and that the content of the compound B is 0 to 0.5 mass %. The fluidity is decreased when the content of the compound A is less than 0.1 mass %, and when the sum of the contents of the compounds A and B exceeds 5 mass %, the fluidity is improved however, curing performance and heat resistance after curing are decreased. Therefore, those range is not desirable. Especially, concerning the compound B, it is particularly preferable that the adjustments of the reaction and distillation are facilitated when the content is made less than 0.1 mass % by sufficient distillation under reduced pressure.

When the phenol resin in accordance with the present invention is used as a resin for a sealing material, in order to let it have excellent curing performance, moldabilty, and the like, and excellent heat resistance, moisture resistance, and the like after curing. it is important to control the physical properties of the phenol resin as the following.

Since the content, in the resin, of the compound having two phenolic hydroxyl groups where two phenol molecules are added to one dicyclopentadiene molecule (hereafter, may be called a dinuclear component) much influences viscosity, fluidity, curing performance, and the like of the resin, it is important to adjust the content properly. The content of the dinuclear component in the phenol resin is preferably mentioned as 30 to 90 mass %, especially, a preferable curing performance is shown in the range of 40 to 80 mass %. When the content of the dinuclear component is less than 30 mass %, the fluidity of the resin is decreased to deteriorate the moldability, and when the content is more than 90 mass %, the fluidity is favorable but crosslinking density after curing is decreased, therefore, this is not preferable. The content of the dinuclear component can be controlled mainly by a reaction mole ratio of phenols to dicyclopentadiene, and it is preferable to control the content of the dinuclear component by properly adjusting the mole ratio.

Moreover, since the viscosity of the resin has a large influence on the fluidity at the time of molding, it needs to be properly adjusted. As to the viscosity, it is not specially restricted, however, for example, it is effective to grasp solution viscosity of 50 mass % in n-butanol, and the viscosity is preferred to be in the range of 50 mm²/sec to 250 mm²/sec, especially, the resin controlled in the range of 70 mm²/sec to 200 mm²/sec viscosity shows an excellent fluidity.

Moreover, since the content of phenolic hydroxyl group in the resin has an influence on the curing performance or the like, the content needs to be properly adjusted. Although the content of phenolic hydroxyl group is not specially restricted, for example, it is preferable that the hydroxyl equivalent weight of the resin measured by an alkali back titration method with acetylated substances in a solution of pyridine-acetic anhydride is in the range of 160 g/eq to 200 g/eq, and especially, the resin adjusted in the range of 165 g/eq to 190 g/eq shows not only excellent curing performance but moreover good balance to fluidity, and the handling characteristic is excellent at the time of molding.

According to the production method described in this specification, the phenol resin satisfying the above-described resin properties can be produced.

The phenol resin obtained as the above in accordance with the present invention is excellent in heat resistance, moisture resistance, and crack-resistance, and further, excellent in moldability because of its excellent fluidity, and is useful as an electrical insulating material, especially as a curing agent of an epoxy resin for a semiconductor sealing material or a laminated sheet, or it is useful as a raw material of the epoxy resin, however, the usage is not specially restricted.

Following the above, the production method of the epoxy resin in accordance with the present invention will be explained below.

The epoxy resin in accordance with the present invention can be obtained by glycidylation of reacting the phenol resin produced by the above-described method, namely, the process (1) with epihalohydrins in the presence of a base catalyst in the following process (2).

The glycidylation can be run by a conventional method. To be more specific, for example the reaction is run by reacting the phenol resin with a glycidyl group-introducing agent such as epichlorohydrin and epibromohydrin in the presence of a base such as sodium hydroxide and potassium hydroxide normally at a temperature of 10 to 150° C., preferably, at a temperature of 30 to 80° C., and then washing with water and drying it.

A use amount of glycidyl group-introducing agent is preferably 2 to 20, more pereferably, 3 to 7 times moles of hydroxyl group of the phenol resin. Moreover, in the case of the reaction, the reaction can be accelerated by distilling water by azeotropic distillation with glycidylizer under reduced pressure.

When the epoxy resin in accordance with the present invention is used in the field of electronics, by-produced salt such as sodium chloride needs to be completely removed in the water-washing process beforehand. In this case, unreacted glycidyl group-introducing agent is recovered by distillation and the reaction liquid is concentrated, and then the concentrate may be dissolved in a solvent and washed with water. As preferable solvents, methyl-isobutyl-ketone, cyclohexanone, benzene, butyl cellosolve, and the like can be mentioned. The rinsed concentrate is further concentrated by heating.

When the epoxy resin of the present invention is used as a resin for a sealing material, in order to let it demonstrate excellent curing performance, moldability, and the like and excellent heat resistance, moisture resistance, and the like after curing, it is important to control the physical properties of the epoxy resin as follows.

Since the content of the compound in which two pieces of glycidyl groups are added to a dinuclear component (hereafter, may be called dinuclear epoxy component) in the resin has a big influence on the viscosity, fluidity, and curing performance of the resin, it is important to properly adjust it. The content of the dinuclear epoxy component is preferred to be in the range of 30 to 90 mass %, especially, the range of 40 to 80 mass % is preferred. When the content is less than 30 mass %, the fluidity is decreased and the decrease has a great influence on the moldability; when the content exceeds 90 mass %, favorable fluidity is obtained but crosslinking density is made lower to worsen the curing performance, therefore, both ranges of content are not preferable.

The content of the epoxy groups in the epoxy resin is normally 200 to 500 g/eq, preferably, 250 to 450 g/eq. When the content of the epoxy groups is less than 500 g/eq, the crosslinking density becomes too low, therefore, this range of content is not preferred.

According to the production method described in the present invention, the epoxy resin satisfying the above physical properties can be produced.

The epoxy resin of the present invention is excellent in fluidity and has favorable moldability, compared with an epoxy resin having a similar structure obtained by a conventional method. Moreover, the epoxy resin of the present invention is excellent in heat resistance and curing performance due to its higher density of epoxy groups, therefore, it is useful as a raw material of an epoxy resin composition for a laminated sheet, and especially, it is very useful for a semiconductor sealing material from the advantage of the excellent solder crack property or the like. Further, the epoxy resin is moreover useful for powder paints, brakeshoes, and the like, and the usage is not specially to be restricted.

Following the above, the epoxy resin composition for a semiconductor sealing material of the present invention will be described below.

The epoxy resin composition of the present invention contains an epoxy resin, a curing agent, and a curing accelerator as essential components, and is characterized in using the epoxy resin of the present invention for the epoxy resin, or using the phenol resin of the present invention as the curing agent.

When the epoxy resin of the present invention is used as an epoxy resin, other epoxy resins may be used together. As the other epoxy resins, any of known epoxy resins can be used, for example, bisphenol A diglycidyl ether type epoxy resin, phenol novolac type epoxy resin, bisphenol A novolac type epoxy resin, bisphenol F novolac type epoxy resin, brominated phenol novelac type epoxy resin, naphthol novolac type epoxy resin, biphenyl type 2-functional epoxy resin, and the like can be mentioned, however, the epoxy resins are not to be restricted to these.

As a curing agent, any of the conventional curing agents used for curing epoxy resins can be used in addition to the phenol resin of the present invention, and is not to be specially restricted, however, for example, the following can be mentioned: phenol novolac resin, ortho-cresol novolac resin, bisphenol A novolac resin, bisphenol F novolac resin, dihydroxy-naphtalene novolac resin, and polyhydric phenols with a xylidene group as a nodal group; phenol aralkyl resin, naphthol resins, fatty amines such as diethylenetriamine, triethylenetetramine; aromatic amines such as meta-pheylenediamine, diaminodiphenylmethane; polyamide resins and these modifications, acid anhydride type curing agents such as maleic anhydride, phthalic anhydride, hexahydrophthal anhydride, pyromellitic acid anhydride; and latent type curing agents such as dicyandiamide, imidazole, bromine trifluoride-amine complex, and guanidine derivatives. For the semiconductor sealing materials, the above-mentioned aromatic hydrocarbon-formaldehyde resins are preferred because they are excellent in curing performance, moldability, and heat resistance, while phenol aralkyl resins are preferred because they are excellent in curing performance, moldability, and low water-absorbing property.

The quantity of the curing agent is not specially limited as far as the quantity is enough to cure the epoxy resin, however, such a quantity is preferred as the number of epoxy groups contained in a single molecule of the epoxy resin is approximately equivalent to the number of active hydrogen in the curing agent.

Any of the known curing accelerators can be used, and for example, phosphorous compound, tertiary amine, imidazole, organometallic salt, Lewis acid, amine complex salt, and the like can be mentioned, and these can be used not only solely but two or more kinds of them can moreover be used together.

An inorganic filler is able to increase mechanical strength and hardness of the semiconductor sealing material, and achieve a low coefficient of water absorption and a low coefficient of linear expansion, and increase a crack prevention effect.

Although the inorganic filler to be used is not to be specially restricted, fused silica, crystal silica, alumina, talc, clay, glass fiber, and the like can be mentioned. Among these, fused silica and crystal silica are generally used especially for a semiconductor sealing material, and fused silica id especially preferred because of its excellent fluidity. Moreover, spherical silica, ground silica, and the like can be used.

A mixing quantity of the inorganic filler is not specially limited, but the quantity is preferred to be in the range of 75 to 95 mass % of a composition, because solder crack resistance is excellent in this range especially in the use for the semiconductor sealing material. In the present invention, fluidity and moldability are not damaged at all even when the mixing quantity is increased to 75 mass % or more.

In addition to the above components, various kinds of known additives such as a colorant, a flame retardant, a mold lubricant, or a coupling agent can properly be mixed as necessary.

Moreover, in order to prepare a molding material using each material of the above, epoxy resins, a curing agent, a curing accelerator, and other additives are mixed uniformly enough by a mixer or the like, and then they are further melt-kneaded by a heat roller or a kneader or the like, and are injection-molded or ground after cooling.

### Embodiments

Next, the present invention will be explained in details by describing examples of the production methods, embodiments, and their comparisons. Here, all the parts in the examples are part by weight unless otherwise specified.

Further, the characteristics of the phenol resin have been measured by the following methods.

1) Content (mass %) of the Compound A

The compound A was isolated from a phenol resin and refined by using preparative GPC, an open column, and the like, and was identified by using NMR or the like. Moreover, when aromatic hydrocarbon compound was not used for the reaction, the quantity of the component (a substance detected within the range of 230 or more and less than 320 in number-average molecular weight in terms of polystyrene) detected in a retention time corresponding to the compound A was measured beforehand by using analytical GPC, and the measured quantity was subtracted from the content of the component corresponding to the retention time when the reaction was run by using the aromatic hydrocarbon compound, and then the content of the compound A to the whole phenol resin was determined from the area ratio of them on the basis of the measured chart of the whole phenol resin. The measurements were carried out on a solution of 1 mass % phenol resin in tetrahydrofuran (THF) by using a high speed liquid chromatography system “Millenium” made by WATERS CO., LTD.

2) Content (mass %) of the Compound B (phenol & DCPD; 1:1 Additive)

The compound B was isolated from a phenol resin and refined by using preparative GPC, an open column, and the like, and was identified by using NMR or the like. Moreover, the-quantity of the component (a substance-detected within the range of 100 or more and less than 230 in number-average molecular weight in terms of polystyrene) corresponding to the compound B was measured by using analytical GPC, and then the content of the compound B to the whole phenol resin was determined from the area ratio of them on the basis of the measured chart of the whole phenol resin. The measurements were carried out on a solution of 1 mass % phenol resin in tetrahydrofuran (THF) by using a high speed liquid chromatography system “Millenium” made by WATERS CO., LTD.

3) OH Equivalent Weight

The OH equivalent weight was determined by heating and refluxing the phenol resin obtained by the production in a mixed solution of pyridine and acetic anhydride, and back-titrating the reacted solution with potassium hydroxide.

4) Softening Point

The softening point was measured by the ring and ball type softening point measuring method in accordance with JIS K 2207.

5) Solution Viscosity of 50 mass % Solution in n-butanol

A solution of 50±0.001% solid content concentration in n-butanol was used, and the solution viscosity thereof was measured by a reverse flow Cannon-Fenske viscometer at 25° C. water temperature in a constant-temperature bath.

6) Content of Dinuclear Component and Content of Dinuclear Epoxy Component

A solution of 1 mass % phenol resin in THF was used, and the content was detected by a differential refractometer detector “WATERS 410” made by WATERS CO., LTD., and was measured by a high speed liquid chromatography “Millenium” of the Company.

<Example of Production 1>

1222 g (13moles) of phenol was put in a 4-mouth flask provided with a stirrer and a thermometer, and 61 g of toluene and 17 g of bromine trifluoride-phenol complex were added thereto and stirred sufficiently. Thereafter, while stirring them, 177 g (1.3 moles) of dicyclopentadiene was added thereto in two hours with the system kept at 70° C. After that, the system temperature was raised up to 140° C., and then heated and stirred at 140° C. for 3 hours. After the system temperature was lowered to 70° C., 51 g of hydrotalcite “KW-1000” (a trade name, produced by Kyowa Chemical Industry Co., Ltd.) was added to the obtained reaction product solution to inactivate the reaction. While distilling and recovering the unreacted phenol from the solution obtained by filtering the reaction solution, the temperature of the reaction solution was raised to 270° C., and was kept for 3 hours with nitrogen bubbling under reduced pressure of 0.13kPa (1 Torr). As a result, 379 g of the reddish brown phenol resin (I) was obtained. The softening point of this resin was 91° C., and the hydroxyl equivalent weight was 172 g/eq. The viscosity of the solution of 50 mass % in n-butanol was 88 mm²/sec at 25° C. Moreover, the resin contained 1.8 mass % of the compound A and 0.02 mass % of the compound B. Further, the content of the dinuclear component was 70 mass %.

740 g (8 moles) of epichlorohydrin was added to 342 g of this resin and dissolved. 440 g (2.2 moles) of the aqueous solution of 20% NaOH was dropped therein in 8 hours while stirring, and the stirring was continued for another 30 minutes and then the mixture was still standing. After the salt water in the lower layer was disposed of and the epichlorohydrin was distilled and recovered at 150° C., 750 g of methyl isobutyl ketone (MIBK) was added to the crude resin, and further, 250 g of water was added thereto to rinse it at 80° C. Then, after the lower layer rinsing water was disposed of, 419 g of the epoxy resin (I) was obtained by removing the MIBK solvent through dehydrating filtration at 150° C. The epoxy resin (I) had the softening point at 60° C., and the melt viscosity at 150° C. was 0.6 poise, and the epoxy equivalent weight was 263 g/eq. Moreover, the content of dinuclear epoxy component was 55 mass %.

<Example of Production 2>

380 g of a reddish brown phenol resin (II) was obtained by the same method as the example of production 1 except that the amount of addition of toluene was changed to 122 g when producing the phenol resin in the example of production 1. This resin had the softening point at 89° C., and the hydroxyl equivalent weight was 173 g/eq. The viscosity of the solution of 50 mass % in n-butanol was 85 mm²/sec at 25° C. Moreover, this resin contained the compound A by 3 mass %, and the compound B by 0.03 mass %. Further, the content of dinuclear component was 68 mass %. Using this phenol resin (II) as a raw material, 418 g of the epoxy resin (II) was obtained by the completely same method as that for the example of production 1. This resin was a brown solid, and had the softening point at 58° C., and the melt viscosity at 150° C. was 0.5 poise, and the epoxy equivalent weight was 265 g/eq. Further, the content of dinuclear epoxy component was 53 mass %.

<Comparative example of Production 1>

378 g of a reddish brown phenol resin (III) was obtained by the same method as the example of production 1 except that the amount of addition of toluene was changed to 0 g when producing the phenol resin in the example of production 1. This resin had the softening point at 93° C., and the hydroxyl equivalent weight was 171 g/eq. The viscosity of the solution of 50 mass % in n-butanol was 93 mm²/sec at 25° C. Moreover, this resin contained the compound A by 0 mass %, and the compound B by 0.03 mass %. Further, the content of dinuclear component was 72 mass %. Using this phenol resin (III) as a raw material, 420 g of the epoxy resin (III) was obtained by the same method as that for the example of production 1. This resin was a brown solid, and had the softening point at 63° C., and the melt viscosity at 150° C. was 0.8 poise, and the epoxy equivalent weight was 263 g/eq. Further, the content of dinuclear epoxy component was 57 mass %.

<Comparative example of Production 2>

378 g of a reddish brown phenol resin (IV) was obtained by the same method as the example of production 1 except that the amount of addition of toluene was changed to 366 g when producing the phenol resin in the example of production 1. This resin had the softening point at 85° C., and the hydroxyl equivalent weight was 178 g/eq. The viscosity of the solution of 50 mass % in n-butanol was 81 mm²/sec at 25° C. Moreover, this resin contained the compound A by 8 mass %, and the compound B by 0.03 mass %. Further, the content of dinuclear component was 63 mass %. Using this phenol resin (IV) as a raw material, 420 g of the epoxy resin (IV) was obtained by the same method as that for the example of production 1. This resin was a brown solid, and had the softening point at 54° C., and the melt viscosity at 150° C. was 0.3 poise, and the epoxy equivalent weight was 273 g/eq. Further, the content of dinuclear epoxy component was 49 mass %.

<Embodiments 1, 2 and Comparative Examples 1, 2>

Comparisons were made between fluidities and between curing properties as epoxy resin compositions for which phenol resins were used as curing agents. Flat packages of 2 mm thickness were made as test pieces for evaluation purpose by kneading the mixtures made according to the recipe shown in Table 1 by heat-rolling at 100° C. for 8 minutes, then grinding the mixtures and making them into tablets with 120 to 140 MP (1200 to 1400 kg/cm²) of pressure, and sealing with them by a transfer molding machine under the conditions of a plunger pressure at 8 MPa (80 kg/cm²), a metallic mold temperature at 175° C., and a molding time of 100 sec. After that, post cure was done at 175° C. for 8 hours. As an index of fluidity of an epoxy resin composition, gel time measurements and spiral flow measurements by a test metallic mold under the conditions of 175° C., 7 MPa (70 kg/cm²), and 120 sec were carried out. Further, glass transition temperatures as the indices of the curing properties were measured by a DMA using the test pieces for evaluation. Further, water-absorption was measured by performing water absorption treatment by leaving the test pieces in the atmosphere at 85° C. and 85% RH for 168 hours. Furthermore, crack incidence rates was examined at the time of dipping them in a 260° C. solder bath for 10 seconds. Table 1 shows these results. The embodiments 1 and 2 present good balances in fluidity and heat resistance, while the comparative example 1 shows bad fluidity, and the comparative example 2 is inferior in heat resistance.

Here, Tamanol 758 (produced by Arakawa Chemical Industries, Ltd. the softening point: 83° C., and a hydroxyl equivalent weight: 104 g/eq) was employed as the phenol novolac. ESCN-220L (produced by Sumitomo Chemical Co., Ltd. Softening point: 66° C., and the epoxy equivalent weight: 212 g/eq) was employed as the ortho-cresol novolac epoxy.

TABLE 1

| | | | | Comparative | |
|---|---|---|---|---|---|
| | | Embodiments | | examples | |
| | unit | 1 | 2 | 1 | 2 |
| Mixed components | | | | | |
| Phenol resin (I) | g | 33 | — | — | — |
| Phenol resin (II) | g | — | 33 | — | — |
| Phenol resin (III) | g | — | — | 33 | — |
| Phenol resin (IV) | g | — | — | — | 33 |
| Phenol novolac | g | 8 | 8 | 8 | 8 |
| Ortho-cresol novolac epoxy | g | 59 | 59 | 59 | 59 |
| Tri-phenylphosphine | g | 1 | 1 | 1 | 1 |
| Carnauba wax | g | 0.5 | 0.5 | 0.5 | 0.5 |
| Antimony trioxide | g | 8 | 8 | 8 | 8 |
| Carbon black | g | 0.5 | 0.5 | 0.5 | 0.5 |
| Coupling agent | g | 0.5 | 0.5 | 0.5 | 0.5 |
| Fused silica powder | g | 630 | 630 | 630 | 630 |
| Filling factor | mass | 85 | 85 | 85 | 85 |
| | % | | | | |
| Evaluation | | | | | |
| Spiral flow | cm | 77 | 81 | 70 | 90 |
| Gel time | sec | 47 | 50 | 42 | 56 |
| Glass transition temperature | ° C. | 161 | 160 | 162 | 151 |
| Water absorption | % | 0.11 | 0.11 | 0.12 | 0.12 |
| Crack incidence rate | % | 0 | 0 | 0 | 0 |

<Embodiments 3, 4 and Comparative Examples 3, 4>

Comparisons were made between fluidities and between curing properties of the compositions using epoxy resins made from phenol resins as raw materials. Flat packages of 2 mm thickness were made as test pieces for evaluation purpose by kneading the mixtures made according to the recipe shown in Table 2 by heat-rolling at 100° C. for 8 minutes, then grinding the mixture and making them into tablets with 120 to 140 MPa (1200 to 1400 kg/cm²) of pressure, and using them to be sealed under the conditions of a plunger pressure at 8 MPa (80 kg/cm²) by a transfer molding machine, a metallic mold temperature at 175° C., and a molding time of 100 sec. After that, post cure was done at 175° C. for 8 hours. Using a gel time as an index of fluidity of an epoxy resin compound, and a test use metallic mold, spiral flow measurements were carried out under the conditions of 175° C., 7 MPa (70 kg/cm²), and 120 sec. Further, glass transition temperatures were measured by a DMA as the indices of curing properties by using the test pieces for evaluation. Further, water-absorption was measured by performing water absorption treatment by leaving the test pieces in the atmosphere at 85° C. and 85% RH for 168 hours. Furthermore, crack incidence rates were examined at the time of dipping them in a 260° C. solder bath for 10 seconds. Table 2 shows these results. The embodiments 3 and 4 present good balances in fluidity and heat resistance, while the comparative example 3 shows bad fluidity, and the comparative example 4 is inferior in heat resistance.

Here, Phenolite TD-2131 (produced by Dainippon Ink and Chemicals, Incorporated. softening point: 80° C., and the hydroxyl equivalent weight: 104 g/eq) was employed as the phenol novolac.

TABLE 2

| | | | | Comparative | |
|---|---|---|---|---|---|
| | | Embodiments | | examples | |
| | unit | 3 | 4 | 3 | 4 |
| Mixed components | | | | | |
| Phenol resin (I) | g | 72 | — | — | — |
| Phenol resin (II) | g | — | 72 | — | — |
| Phenol resin (III) | g | — | — | 72 | — |
| Phenol resin (IV) | g | — | — | — | 72 |
| Phenol novolac | g | 28 | 28 | 28 | 28 |
| Tri-phenylphosphine | g | 1 | 1 | 1 | 1 |
| Carnauba wax | g | 0.5 | 0.5 | 0.5 | 0.5 |
| Antimony trioxide | g | 8 | 8 | 8 | 8 |
| Carbon black | g | 0.5 | 0.5 | 0.5 | 0.5 |
| Coupling agent | g | 0.5 | 0.5 | 0.5 | 0.5 |
| Fused silica powder | g | 630 | 630 | 630 | 630 |
| Filling factor | mass | 85 | 85 | 85 | 85 |
| | % | | | | |
| Evaluation | | | | | |
| Spiral flow | cm | 81 | 85 | 74 | 93 |
| Gel time | sec | 52 | 54 | 50 | 58 |
| Glass transition temperature | ° C. | 161 | 160 | 161 | 152 |
| Water absorption | % | 0.11 | 0.11 | 0.12 | 0.11 |
| Crack incidence rate | % | 0 | 0 | 0 | 0 |

### Industrial Applicability

According to the present invention, phenol resin compositions, epoxy resin compositions, and semiconductor sealing materials which have favorable fluidity and are excellent not only in moldability when sealing semiconductors, but moreover in heat resistance after sealing and curing.

What is claimed is:

1. A phenol resin produced by making dicyclopentadiene react with phenols in the presence of an acid catalyst; which contains at least 0.1 mass % of a compound A represented by the following general formula (1); and moreover which contains 0.1 to 5 mass % as a summed quantity of the compound A and a compound B represented by the following general formula (2). 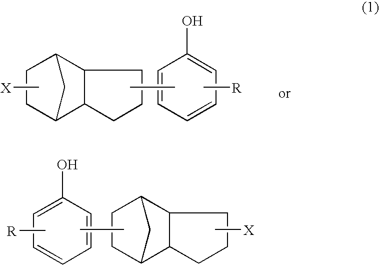
(where X is an aromatic hydrocarbon with 6 to 10 carbon numbers, the kind of R and the number of bonds to an aromatic ring are determined depending on the kind of phenols to be used for the reaction.) 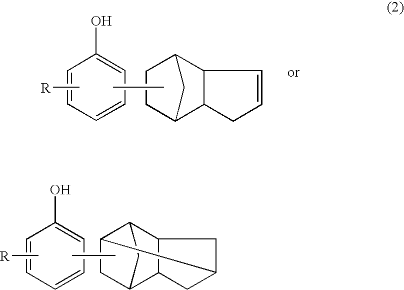
(where the kind of R and the number of bonds to the aromatic ring are determined depending on the kind of phenols to be used for the reaction.)

2. A production method of a phenol resin containing a compound A at least by 0.1 mass % and a 0.1 to 5 mass % summed quantity of said compound A and a compound B by making 0.5 to 20 parts by weight of aromatic carbon compound coexist with to 100 parts by weight of the phenols, when producing the phenol resin by reacting dicyclopentadiene with phenols in the presence of an acid catalyst.

3. An epoxy resin obtained from a reaction between the phenol resin as claimed in claim 1 and epihalohydrins.

4. An production method of epoxy resin including the processes 1) and 2) mentioned below;
1) the process for producing the phenol resin by the production method as claimed in claim 2, and
2) the process for producing the epoxy resin by making the phenol resin obtained from- the process 1) react with epihalohydrins in the presence of a base catalyst.

5. An epoxy resin composition for a semiconductor sealing material, containing an epoxy resin, a curing agent, a curing accelerator, and an inorganic filler as the essential components, wherein the curing agent is the phenol resin as claimed in claim 1.

6. An epoxy resin composition for the semiconductor sealing material, containing the epoxy resin as claimed in claim 3, a curing agent, a curing accelerator, and an inorganic filler as the essential components.
